(19) United States
(12) Patent Application Publication
(10) Pub. No.: US 2020/0133149 A1
(43) Pub. Date: Apr. 30, 2020

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Takanori Ueno, Nagareyama-shi (JP); Kumiko Takizawa, Saitama-shi (JP); Kan Tanabe, Matsudo-shi (JP); Haruhiko Mitsuda, Nagareyama-shi (JP); Ikuyo Kuroiwa, Tokyo (JP); Tsuyoshi Shimada, Kashiwa-shi (JP); Wataru Kitamura, Abiko-shi (JP); Shinji Takagi, Yokohama-shi (JP); Tatsuya Ikezue, Toride-shi (JP)

(21) Appl. No.: 16/658,591

(22) Filed: Oct. 21, 2019

(30) Foreign Application Priority Data
Oct. 24, 2018 (JP) 2018-200118

(51) Int. Cl. G03G 5/14; G03G 5/06; G03G 5/05; G03G 21/18; G03G 15/00

(52) U.S. Cl. CPC G03G 5/144; G03G 5/0696; G03G 5/0564; G03G 5/0668; G03G 15/75; G03G 5/0664; G03G 5/0672; G03G 5/0614; G03G 21/1814; G03G 5/0677

(57) ABSTRACT

The present disclosure provides an electrophotographic photosensitive member that can suppress a black spot and an exposure memory. The electrophotographic photosensitive member has a support, an undercoat layer and a photosensitive layer having a mono-layer structure in this order, wherein the undercoat layer contains a binder resin and strontium titanate particles; and the photosensitive layer having a mono-layer structure contains a binder resin, a charge generation material, a hole transport material and an electron transport material.

### BACKGROUND OF THE INVENTION

### Field of the Invention

The present disclosure relates to an electrophotographic photosensitive member, a process cartridge and an electrophotographic apparatus having the electrophotographic photosensitive member.

### Description of the Related Art

An electrophotographic apparatus using an electrophotographic system is widely and generally used for a copying machine, a facsimile machine and a printer. As an electrophotographic photosensitive member that can be suitably used for such an electrophotographic apparatus, an organic electrophotographic photosensitive member (OPC) using an organic photoconductive material has been progressively developed and widespread.

In particular, an electrophotographic photosensitive member having a photosensitive layer having a mono-layer structure has attracted attention because its manufacturing cost is low, compared to an electrophotographic photosensitive member having a lamination type photosensitive layer.

The single-layer type photosensitive member often has a photosensitive layer having a mono-layer structure directly provided on an electroconductive substrate, without having an undercoat layer. However, when a photosensitive member in which the photosensitive layer having a mono-layer structure was directly provided on the electroconductive substrate is used, an image defect called a black spot sometimes occurred.

On the other hand, when the undercoat layer was provided on the electroconductive substrate, an exposure memory occurred in some cases. The exposure memory is a phenomenon in which an afterimage of an image formed in a step in a previous cycle of the electrophotographic process of the electrophotographic photosensitive member appears in a step in the following cycle of the electrophotographic process. In recent years, a level of an image quality required for electrophotographic apparatuses has become severe, and it has been required to suppress the black spot and the exposure memory which were not a problem in the past.

In Japanese Patent Application Laid-Open No. 2018-10240, a technology is described in which a photosensitive layer having a mono-layer structure is provided on an undercoat layer containing zinc oxide particles.

### SUMMARY OF THE INVENTION

The above object is achieved by the present disclosure described below. Specifically, the electrophotographic photosensitive member according to the present disclosure is an electrophotographic photosensitive member having a support, an undercoat layer and a photosensitive layer having a mono-layer structure in this order, wherein the undercoat layer contains a binder resin and strontium titanate particles, and the photosensitive layer having a mono-layer structure contains a binder resin, a charge generation material, a hole transport material, and an electron transport material.

Further features of the present disclosure will become apparent from the following description of exemplary embodiments with reference to the attached drawings.

### BRIEF DESCRIPTION OF THE DRAWINGS

FIG. 1 illustrates a schematic view showing one example of a layer configuration of an electrophotographic photosensitive member of the present disclosure.

FIG. 2 illustrates a conceptual block diagram showing one example of a process cartridge of the present disclosure.

FIG. 3 illustrates a conceptual block diagram showing one example of an electrophotographic apparatus of the present disclosure.

FIG. 4 illustrates a schematic view of a chart used for evaluation of exposure memory.

### DESCRIPTION OF THE EMBODIMENTS

As a result of studies by the present inventors, there has been the case where it has been difficult for the technology described in Japanese Patent Application Laid-Open No. 2018-10240 to suppress the black spot and the exposure memory.

Accordingly, an object of the present disclosure is to provide an electrophotographic photosensitive member that can suppress the black spot and the exposure memory.

The present disclosure will be described in detail below with reference to preferred embodiments.

In the case of a single-layer type of photosensitive member, it is necessary to give both the function of transporting a positive hole and the function of transporting an electron to one layer (photosensitive layer having a mono-layer structure), and accordingly it is necessary to mix an electron transport material, a hole transport material and further a charge generation material, in one layer. It is considered that the transportability of the electric charges generated by exposure becomes easy to be lowered, compared to the lamination type photosensitive layer, because the functions are concentrated in one layer.

In particular, when an undercoat layer has been provided so as to suppress the black spot and the like, it is considered that retention of electric charges generated by exposure tends to occur at an interface between the undercoat layer and the photosensitive layer having a mono-layer structure.

In the prior art, metal particles of zinc oxide or the like were contained in the undercoat layer and imparted electroconductivity thereto, but it has been found that the method is insufficient for suppressing the retention of the electric charges.

As a result of studies by the present inventors, it has been found that both the black spot and the exposure memory can be suppressed by a structure in which the undercoat layer contains strontium titanate and a binder resin, and the photosensitive layer having a mono-layer structure contains a binder resin, a charge generation material, a hole transport material and an electron transport material.

The reason why the problem can be solved by the above structure will be described below.

The detailed mechanism is not known, but it is considered that when the strontium titanate is used in the undercoat layer, the resistance at the interface between the undercoat layer and the photosensitive layer having a mono-layer structure is greatly lowered. This is considered to be because the strontium titanate is excellent in the dispersibility in the undercoat layer, which facilitates the transfer of the electric charge with the electron transport material and the charge transport material.

The above mechanism enables the present disclosure to achieve the effect.

[Electrophotographic Photosensitive Member]

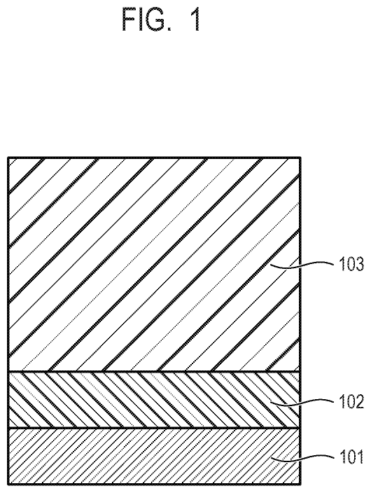

FIG. 1 illustrates a schematic view showing one example of a layer configuration of the electrophotographic photosensitive member of the present disclosure. The electrophotographic photosensitive member of the present disclosure has a support 101, an undercoat layer 102 and a photosensitive layer having a mono-layer structure 103.

A method for producing the electrophotographic photosensitive member of the present disclosure includes a method of preparing a coating liquid for each layer which will be described later, applying the liquid in the order of desired layers, and drying the liquid. Application methods of the coating liquid at this time include dip coating, spray coating, ink jet coating, roll coating, die coating, blade coating, curtain coating, wire bar coating and ring coating. Among others, the dip coating is preferable from the viewpoint of efficiency and productivity.

The support and each layer will be described below.

<Support>

In the present disclosure, the electrophotographic photosensitive member has a support. In the present disclosure, it is preferable that the support is an electroconductive support having electroconductivity. In addition, shapes of the support include a cylindrical shape, a belt shape and a sheet shape. Among others, the cylindrical support is preferable. In addition, the surface of the support may be subjected to electrochemical treatment such as anodization, blast treatment, cutting treatment and the like.

As a material of the support, a metal, a resin, glass and the like are preferable.

The metals include aluminum, iron, nickel, copper, gold, stainless steel, and alloys thereof. Among others, an aluminum support using aluminum is preferable.

In addition, the electroconductivity may be imparted to the resin and the glass by treatment such as mixing of or coating with an electroconductive material.

<Electroconductive Layer>

In the present disclosure, an electroconductive layer may be provided on the support. Due to the electroconductive layer being provided, the support can conceal scratches and irregularities on its surface and can control the reflection of light on its surface.

It is preferable that the electroconductive layer contains electroconductive particles and a resin.

Materials of the electroconductive particles include a metal oxide, a metal and carbon black. The metal oxide includes zinc oxide, aluminum oxide, indium oxide, silicon oxide, zirconium oxide, tin oxide, titanium oxide, magnesium oxide, antimony oxide and bismuth oxide. The metal includes aluminum, nickel, iron, nichrome, copper, zinc and silver.

Among others, it is preferable to use a metal oxide as the electroconductive particles, and in particular, it is more preferable to use titanium oxide, tin oxide or zinc oxide.

When the metal oxide is used as the electroconductive particles, the surface of the metal oxide may be treated with a silane coupling agent, or the metal oxide may be doped with an element such as phosphorus, aluminum or an oxide thereof.

In addition, the electroconductive particles may have a layered structure having a core material particle and a covering layer with which the particle is covered. The core material particle includes those of titanium oxide, barium sulfate and zinc oxide. The covering layer includes those of a metal oxide such as tin oxide.

In addition, when the metal oxide is used as the electroconductive particles, the volume average particle diameter is preferably 1 nm or larger and 500 nm or smaller, and is more preferably 3 nm or larger and 400 nm or smaller.

The resin includes a polyester resin, a polycarbonate resin, a polyvinyl acetal resin, an acrylic resin, a silicone resin, an epoxy resin, a melamine resin, a polyurethane resin, a phenol resin and an alkyd resin.

In addition, the electroconductive layer may further contain a shielding agent such as a silicone oil, resin particles and titanium oxide.

An average film thickness of the electroconductive layer is preferably 1 μm or larger and 50 μm or smaller, and is particularly preferably 3 μm or larger and 40 μm or smaller.

The electroconductive layer can be formed by preparing a coating liquid for an electroconductive layer containing each of the above materials and a solvent, forming the coating film of the coating liquid, and drying the coating film. The solvent used for the coating liquid includes an alcohol-based solvent, a sulfoxide-based solvent, a ketone-based solvent, an ether-based solvent, an ester-based solvent and an aromatic hydrocarbon-based solvent. Dispersion methods for dispersing the electroconductive particles in the coating liquid for the electroconductive layer include a method using a paint shaker, a sand mill, a ball mill, or a liquid collision type high speed disperser.

<Undercoat Layer>

In the present disclosure, an undercoat layer is provided on the support or the electroconductive layer.

The undercoat layer of the electrophotographic photosensitive member of the present disclosure contains strontium titanate particles and a binder resin. The undercoat layer which has been provided can thereby enhance an adhesion function between layers and impart a charge injection inhibition function.

The binder resin includes a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamide acid resin, a polyimide resin, a polyamide imide resin and a cellulose resin.

In addition, the undercoat layer may further contain an electron transport material, a metal oxide, a metal, an electroconductive polymer and the like, for the purpose of enhancing its electric characteristics. Among others, it is preferable to use the electron transport material and the metal oxide.

The electron transport material includes a quinone compound, an imide compound, a benzimidazole compound, a cyclopentadienylidene compound, a fluorenone compound, a xanthone compound, a benzophenone compound, a cyano vinyl compound, a halogenated aryl compound, a silole compound and a boron-containing compound. The undercoat layer may be formed as a cured film by using an electron transport material having a polymerizable functional group as the electron transport material, and copolymerizing the electron transport material with a monomer having a polymerizable functional group.

The polymerizable functional group which the monomer having the polymerizable functional group has includes an isocyanate group, a block isocyanate group, a methylol group, an alkylated methylol group, an epoxy group, a metal alkoxide group, a hydroxyl group, an amino group, a carboxyl group, a thiol group, a carboxylic acid anhydride group and a carbon-carbon double bond group.

The metal oxide includes indium tin oxide, tin oxide, indium oxide, titanium oxide, zinc oxide, aluminum oxide and silicon dioxide. The metal includes gold, silver and aluminum.

In addition, the undercoat layer may further contain an additive.

It is preferable for the average film thickness of the undercoat layer to be 0.1 or larger and 50 μm or smaller, is more preferable to be 0.2 μm or larger and 40 or smaller, and is particularly preferable to be 0.3 μm or larger and 30 μm or smaller.

It is preferable that the ten-point average roughness Rzⱼᵢₛ of the surface of the undercoat layer, which is defined by JIS B0601: 2001, is 0.5 μm or larger and 1.5 or smaller, from the viewpoint of suppression for the black spot.

The undercoat layer can be formed by preparing a coating liquid for the undercoat layer containing each of the above materials and a solvent, forming the coating film of the coating liquid, and drying and/or curing the coating film. The solvent used for the coating liquid includes an alcohol-based solvent, a ketone-based solvent, an ether-based solvent, an ester-based solvent and an aromatic hydrocarbon-based solvent.

<Photosensitive Layer Having a Mono-Layer Structure>

The photosensitive layer having a mono-layer structure of the electrophotographic photosensitive member of the present disclosure mainly contains a binder resin, a charge generation material, a hole transport material and an electron transport material.

The binder resin includes a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole and polysilane. Among others, the polycarbonate resin and the polyarylate resin are more preferable.

The charge generation material includes an azo pigment, a perylene pigment, a polycyclic quinone pigment, an indigo pigment and a phthalocyanine pigment. Among others, the azo pigment and the phthalocyanine pigment are preferable. Among others, oxytitanium phthalocyanine pigment, chlorogallium phthalocyanine pigment and hydroxygallium phthalocyanine pigment are preferable.

The electron transport materials include a quinone compound, a diimide compound, a hydrazone compound, a malononitrile-based compound, a thiopyran-based compound, a trinitrothioxanthone-based compound, a 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacri dine, succinic anhydride, maleic anhydride and dibromomaleic anhydride. Examples of the quinone-based compound include a diphenoquinone-based compound, an azoquinone-based compound, an anthraquinone-based compound, a naphthoquinone-based compound, a nitroanthraquinone-based compound and a dinitroanthraquinone-based compound.

Specifically, the above compound includes those of General Formula (1), General Formula (2), General Formula (3), General Formula (4) and General Formula (5).

Among the formulae, it is preferable that the electron transport material has a structure represented by General Formula (1), General Formula (2), General Formula (3) and General Formula (4), from the viewpoint of suppression of the exposure memory.

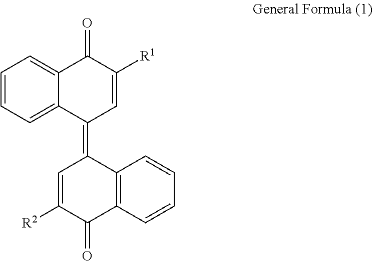

In General Formula (1), R¹ and R² each independently represent a hydrogen atom, a halogen atom, a cyano group, a substituted or unsubstituted alkyl group having 1 or more and 6 or less carbon atoms, a substituted or unsubstituted alkenyl group having 2 or more and 6 or less carbon atoms, a substituted or unsubstituted alkoxy group having 1 or more and 6 or less carbon atoms, or a substituted or unsubstituted aryl group having 6 or more and 14 or less carbon atoms.

It is preferable that the halogen atom (halogen group) represented by R¹ and R² in General Formula (1) is a chlorine atom (chloro group).

As the alkyl group having 1 or more and 6 or less carbon atoms represented by R¹ and R² in General Formula (1), an alkyl group having 1 or more and 5 or less carbon atoms is preferable, and a methyl group, a tert-butyl group or a 1,1-dimethylpropyl group is more preferable. The alkyl group having 1 or more and 6 or less carbon atoms may have a substituent. Examples of the substituent include a halogen atom, a hydroxyl group, an alkoxy group having 1 or more and 6 or less carbon atoms, and an aryl group which has 6 or more and 14 or less carbon atoms and may further have a substituent, and a cyano group. As a substituent which the alkyl group having 1 or more and 6 or less carbon atoms has, an aryl group having 6 or more and 14 or less carbon atoms is preferable, and a phenyl group is more preferable. The number of substituents is not limited in particular, but is preferably 3 or less. Examples of the substituent that the aryl group having 6 or more and 14 or less carbon atoms, which is a substituent, further has include a halogen atom, a hydroxyl group, an alkyl group having 1 or more and 6 or less carbon atoms, an alkoxy group having 1 or more and 6 or less carbon atoms, a nitro group, a cyano group, an alkanoyl group having 2 or more and 7 or less carbon atoms (carbonyl group which has an alkyl group having 1 or more and 6 or less carbon atoms), a benzoyl group, a phenoxy group, an alkoxycarbonyl group having 2 or more and 7 or less carbon atoms (carbonyl group which has an alkoxy group having 1 or more and 6 or less carbon atoms), and a phenoxycarbonyl group.

The alkenyl group having 2 or more and 6 or less carbon atoms represented by R¹ and R² in General Formula (1) may have a substituent. Examples of the substituent include a halogen atom, a hydroxyl group, an alkoxy group having 1 or more and 6 or less carbon atoms, an aryl group having 6 or more and 14 or less carbon atoms, and a cyano group. The number of substituents is not limited in particular, but is preferably 3 or less.

The alkoxy group having 1 or more and 6 or less carbon atoms represented by R¹ and R² in General Formula (1) may have a substituent. Examples of the substituent include a halogen atom, a hydroxyl group, an alkoxy group having 1 or more and 6 or less carbon atoms, an aryl group having 6 or more and 14 or less carbon atoms, and a cyano group. The number of substituents is not limited in particular, but is preferably 3 or less.

As the aryl group having 6 or more and 14 or less carbon atoms represented by R¹ and R² in General Formula (1), a phenyl group is preferable. The aryl group having 6 or more and 14 or less carbon atoms may have a substituent. Examples of the substituent include a halogen atom, a hydroxyl group, an alkyl group having 1 or more and 6 or less carbon atoms, an alkoxy group having 1 or more and 6 or less carbon atoms, a nitro group, a cyano group, an alkanoyl group having 2 or more and 7 or less carbon atoms (carbonyl group which has an alkyl group having 1 or more and 6 or less carbon atoms), a benzoyl group, a phenoxy group, an alkoxycarbonyl group having 2 or more and 7 or less carbon atoms (carbonyl group which has an alkoxy group having 1 or more and 6 or less carbon atoms), a phenoxycarbonyl group, an aryl group having 6 or more and 14 or less carbon atoms, and a biphenyl group. As the aryl group having 6 or more and 14 or less carbon atoms, an alkyl group having 1 or more and 6 or less carbon atoms or a nitro group is preferable, and a methyl group, an ethyl group or a nitro group is more preferable. The number of substituents is not limited in particular, but is preferably 3 or less.

It is preferable that R¹ and R² in General Formula (1) each independently represent an alkyl group having 1 or more and 5 or less carbon atoms. R¹ and R² may represent the same group among the alkyl groups having 1 or more and 5 or less carbon atoms, and may represent different groups from each other among the alkyl groups having 1 or more and 5 or less carbon atoms.

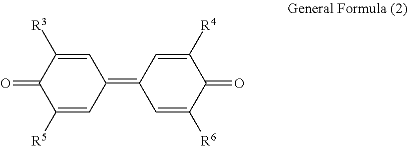

In General Formula (2), R³, R⁴, R⁵ and R⁶ each independently represent a hydrogen atom, a halogen atom, a cyano group, a substituted or unsubstituted alkyl group having 1 or more and 6 or less carbon atoms, a substituted or unsubstituted alkenyl group having 2 or more and 6 or less carbon atoms, a substituted or unsubstituted alkoxy group having 1 or more and 6 or less carbon atoms, or a substituted or unsubstituted aryl group having 6 or more and 14 or less carbon atoms.

It is preferable that the halogen atom (halogen group) represented by R³, R⁴, R⁵ and R⁶ in General Formula (2) is a chlorine atom (chloro group).

As the alkyl group having 1 or more and 6 or less carbon atoms represented by R³, R⁴, R⁵ and R⁶ in General Formula (2), an alkyl group having 1 or more and 5 or less carbon atoms is preferable, and a methyl group, a tert-butyl group or a 1,1-dimethylpropyl group is more preferable. The alkyl group having 1 or more and 6 or less carbon atoms may have a substituent. Examples of the substituent include a halogen atom, a hydroxyl group, an alkoxy group having 1 or more and 6 or less carbon atoms, and an aryl group which has 6 or more and 14 or less carbon atoms and may further have a substituent, and a cyano group. As a substituent which the alkyl group having 1 or more and 6 or less carbon atoms has, an aryl group having 6 or more and 14 or less carbon atoms is preferable, and a phenyl group is more preferable. The number of substituents is not limited in particular, but is preferably 3 or less. Examples of the substituent that the aryl group having 6 or more and 14 or less carbon atoms, which is a substituent, further has include a halogen atom, a hydroxyl group, an alkyl group having 1 or more and 6 or less carbon atoms, an alkoxy group having 1 or more and 6 or less carbon atoms, a nitro group, a cyano group, an alkanoyl group having 2 or more and 7 or less carbon atoms (carbonyl group which has an alkyl group having 1 or more and 6 or less carbon atoms), a benzoyl group, a phenoxy group, an alkoxycarbonyl group having 2 or more and 7 or less carbon atoms (carbonyl group which has an alkoxy group having 1 or more and 6 or less carbon atoms), and a phenoxycarbonyl group.

The alkenyl group having 2 or more and 6 or less carbon atoms represented by R³, R⁴, R⁵ and R⁶ in General Formula (2) may have a substituent. Examples of the substituent include a halogen atom, a hydroxyl group, an alkoxy group having 1 or more and 6 or less carbon atoms, an aryl group having 6 or more and 14 or less carbon atoms, and a cyano group. The number of substituents is not limited in particular, but is preferably 3 or less.

The alkoxy group having 1 or more and 6 or less carbon atoms represented by R³, R⁴, R⁵ and R⁶ in General Formula (2) may have a substituent. Examples of the substituent include a halogen atom, a hydroxyl group, an alkoxy group having 1 or more and 6 or less carbon atoms, an aryl group having 6 or more and 14 or less carbon atoms, and a cyano group. The number of substituents is not limited in particular, but is preferably 3 or less.

As the aryl group having 6 or more and 14 or less carbon atoms represented by R³, R⁴, R⁵ and R⁶ in General Formula (2), a phenyl group is preferable. The aryl group having 6 or more and 14 or less carbon atoms may have a substituent. Examples of the substituent include a halogen atom, a hydroxyl group, an alkyl group having 1 or more and 6 or less carbon atoms, an alkoxy group having 1 or more and 6 or less carbon atoms, a nitro group, a cyano group, an alkanoyl group having 2 or more and 7 or less carbon atoms (carbonyl group which has an alkyl group having 1 or more and 6 or less carbon atoms), a benzoyl group, a phenoxy group, an alkoxycarbonyl group having 2 or more and 7 or less carbon atoms (carbonyl group which has an alkoxy group having 1 or more and 6 or less carbon atoms), a phenoxycarbonyl group, an aryl group having 6 or more and 14 or less carbon atoms, and a biphenyl group. As the aryl group having 6 or more and 14 or less carbon atoms, an alkyl group having 1 or more and 6 or less carbon atoms or a nitro group is preferable, and a methyl group, an ethyl group or a nitro group is more preferable. The number of substituents is not limited in particular, but is preferably 3 or less.

It is preferable that R³, R⁴, R⁵ and R⁶ in General Formula (2) each independently represent an alkyl group having 1 or more and 4 or less carbon atoms, from the viewpoint of suppression of the exposure memory.

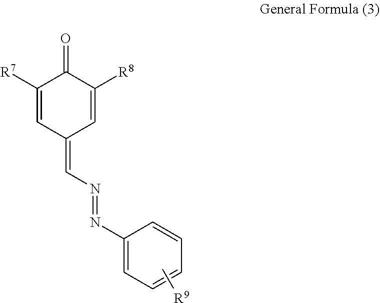

In General Formula (3), R⁷, R⁸ and R⁹ each independently represent a hydrogen atom, a halogen atom, a cyano group, a substituted or unsubstituted alkyl group having 1 or more and 6 or less carbon atoms, a substituted or unsubstituted alkenyl group having 2 or more and 6 or less carbon atoms, a substituted or unsubstituted alkoxy group having 1 or more and 6 or less carbon atoms, or a substituted or unsubstituted aryl group having 6 or more and 14 or less carbon atoms.

It is preferable that the halogen atom (halogen group) represented by R⁷, R⁸ and R⁹ in General Formula (3) is a chlorine atom (chloro group).

As the alkyl group having 1 or more and 6 or less carbon atoms represented by R⁷, R⁸ and R⁹ in General Formula (3), an alkyl group having 1 or more and 5 or less carbon atoms is preferable, and a methyl group, a tert-butyl group or a 1,1-dimethylpropyl group is more preferable. The alkyl group having 1 or more and 6 or less carbon atoms may have a substituent. Examples of the substituent include a halogen atom, a hydroxyl group, an alkoxy group having 1 or more and 6 or less carbon atoms, an aryl group which has 6 or more and 14 or less carbon atoms and may further have a substituent, and a cyano group. As a substituent which the alkyl group having 1 or more and 6 or less carbon atoms has, an aryl group having 6 or more and 14 or less carbon atoms is preferable, and a phenyl group is more preferable. The number of substituents is not limited in particular, but is preferably 3 or less. Examples of the substituent that the aryl group having 6 or more and 14 or less carbon atoms, which is a substituent, further has include a halogen atom, a hydroxyl group, an alkyl group having 1 or more and 6 or less carbon atoms, an alkoxy group having 1 or more and 6 or less carbon atoms, a nitro group, a cyano group, an alkanoyl group having 2 or more and 7 or less carbon atoms (carbonyl group which has an alkyl group having 1 or more and 6 or less carbon atoms), a benzoyl group, a phenoxy group, an alkoxycarbonyl group having 2 or more and 7 or less carbon atoms (carbonyl group which has an alkoxy group having 1 or more and 6 or less carbon atoms), and a phenoxycarbonyl group.

The alkenyl group having 2 or more and 6 or less carbon atoms represented by R⁷, R⁸ and R⁹ in General Formula (3) may have a substituent. Examples of the substituent include a halogen atom, a hydroxyl group, an alkoxy group having 1 or more and 6 or less carbon atoms, an aryl group having 6 or more and 14 or less carbon atoms, and a cyano group. The number of substituents is not limited in particular, but is preferably 3 or less.

The alkoxy group having 1 or more and 6 or less carbon atoms represented by R⁷, R⁸ and R⁹ in General Formula (3) may have a substituent. Examples of the substituent include a halogen atom, a hydroxyl group, an alkoxy group having 1 or more and 6 or less carbon atoms, an aryl group having 6 or more and 14 or less carbon atoms, and a cyano group. The number of substituents is not limited in particular, but is preferably 3 or less.

As the aryl group having 6 or more and 14 or less carbon atoms represented by R⁷, R⁸, and R⁹ in General Formula (3), a phenyl group is preferable. The aryl group having 6 or more and 14 or less carbon atoms may have a substituent. Examples of the substituent include a halogen atom, a hydroxyl group, an alkyl group having 1 or more and 6 or less carbon atoms, an alkoxy group having 1 or more and 6 or less carbon atoms, a nitro group, a cyano group, an alkanoyl group having 2 or more and 7 or less carbon atoms (carbonyl group which has an alkyl group having 1 or more and 6 or less carbon atoms), a benzoyl group, a phenoxy group, an alkoxycarbonyl group having 2 or more and 7 or less carbon atoms (carbonyl group which has an alkoxy group having 1 or more and 6 or less carbon atoms), a phenoxycarbonyl group, an aryl group having 6 or more and 14 or less carbon atoms, and a biphenyl group. As the aryl group having 6 or more and 14 or less carbon atoms, an alkyl group having 1 or more and 6 or less carbon atoms or a nitro group is preferable, and a methyl group, an ethyl group or a nitro group is more preferable. The number of substituents is not limited in particular, but is preferably 3 or less.

It is preferable that R⁷ and R⁸ in General Formula (3) each independently represent an alkyl group having 1 or more and 4 or less carbon atoms, from the viewpoint of suppression of the exposure memory. It is preferable for R⁹ in General Formula (3) to represent a halogen atom, and is more preferable to represent a chlorine atom (chloro group).

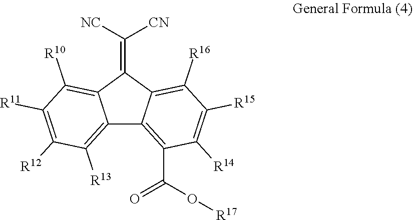

In General Formula (4), R¹⁰, R¹¹, R¹², R¹³, R¹⁴, R¹⁵ and R¹⁶ each independently represent a hydrogen atom, a halogen atom, an alkyl group, an alkoxy group, an aryl group or an aralkyl group. In General Formula (4), R¹⁷ represents an alkyl group, an aryl group or an aralkyl group.

Examples of the halogen atom represented by R¹⁰ to R¹⁶ in General Formula (4) include a fluorine atom, a chlorine atom, a bromine atom and an iodine atom.

Examples of the alkyl group represented by R¹⁰ to R¹⁶ in General Formula (4) include a linear or branched alkyl group having 1 or more and 4 or less carbon atoms (desirably, 1 or more and 3 or less carbon atoms), and specifically include a methyl group, an ethyl group, an n-propyl group, an isopropyl group, an n-butyl group and an isobutyl group.

Examples of the alkoxy group represented by R¹⁰ to R¹⁶ in General Formula (4) include an alkoxy group having 1 or more and 4 or less (desirably, 1 or more and 3 or less) carbon atoms, and specifically include a methoxy group, an ethoxy group, a propoxy group and a butoxy group.

Examples of the aryl group represented by R¹⁰ to R¹⁶ in General Formula (4) include a phenyl group and a tolyl group. Among others, the phenyl group is desirable.

Examples of the aralkyl group represented by R¹⁰ to R¹⁶ in General Formula (4) include a benzyl group, a phenethyl group and a phenylpropyl group.

Examples of the alkyl group represented by R¹⁷ in General Formula (4) include a linear alkyl group having 1 or more and 15 or less carbon atoms (preferably, 3 or more and 12 or less carbon atoms), and a branched alkyl group having 3 or more and 15 or less carbon atoms (preferably, 3 or more and 12 or less carbon atoms).

Examples of the linear alkyl group having 1 or more and 15 or less carbon atoms include a methyl group, an ethyl group, an n-propyl group, an n-butyl group, an n-pentyl group, an n-hexyl group, an n-heptyl group, an n-octyl group, an n-nonyl group and an n-decyl group.

Examples of the branched alkyl group having 3 or more and 15 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group and a tert-decyl group.

Examples of the aryl group represented by R¹⁷ in General Formula (4) include a phenyl group, a methylphenyl group and a dimethylphenyl group.

In General Formula (4), the aralkyl group represented by R¹⁷ includes a group represented by —R¹⁸—Ar, wherein R¹⁸ represents an alkylene group, and Ar represents an aryl group. The alkylene group represented by R¹⁸ includes a linear or branched alkylene group having 1 or more and 8 or less carbon atoms, and includes a methylene group, an ethylene group, an n-propylene group, an isopropylene group, an n-butylene group, an isobutylene group, a sec-butylene group, a tert-butylene group, an n-pentylene group, an isopentylene group, a neopentylene group and a tert-pentylene group.

The aryl group represented by Ar includes a phenyl group, a methylphenyl group and a dimethylphenyl group.

Specific examples of the aralkyl group represented by R¹⁷ in General Formula (4) include a benzyl group, a methylbenzyl group, a dimethylbenzyl group, a phenylethyl group, a methylphenylethyl group, a phenylpropyl group and a phenylbutyl group.

From the viewpoint of suppression of the exposure memory, in the electron transport material of General Formula (4), it is preferable that R¹⁰ to R¹⁶ each independently represent a hydrogen atom, a halogen atom, or an alkyl group, and R¹⁷ represents an alkyl group having 4 or more and 8 or less carbon atoms, an aryl group, or an aralkyl group.

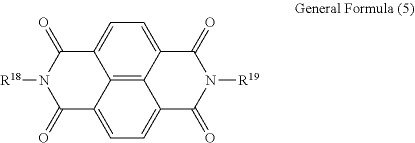

In General Formula (5), R¹⁸ and V each independently represent a hydrogen atom, a halogen atom, a substituted or unsubstituted alkyl group having 1 to 20 carbon atoms, a substituted or unsubstituted alkoxy group having 1 to 20 carbon atoms, a substituted or unsubstituted aryl group having 6 to 20 carbon atoms, or a substituted or unsubstituted amino group. Examples of R¹⁸ and R¹⁹ in the case where R¹⁸ and R¹⁹ are halogen atoms include a chlorine atom, a bromine atom, a fluorine atom and an iodine atom.

When R¹⁸ and R¹⁹ are a substituted or unsubstituted alkyl group, the number of carbon atoms of the alkyl group is 1 to 20, is preferably 1 to 12, and is more preferably 1 to 8. For information, the number of carbon atoms of the alkyl group does not contain the number of carbon atoms of the substituent which is bonded to the alkyl group. The structure of the alkyl group may be any of linear, branched, cyclic and combination structures thereof. Examples of the substituent which the alkyl group may have include a halogen atom, a hydroxyl group, an alkoxy group having 1 to 4 carbon atoms, a carbonyl group, an ester group and a cyano group.

Specific compounds of the electron transport material are shown below, but the compounds are not limited to the specific compounds.

Preferable examples of General Formula (1) include compounds represented by chemical formulae (ETM1-1, ETM1-2 and ETM1-3).

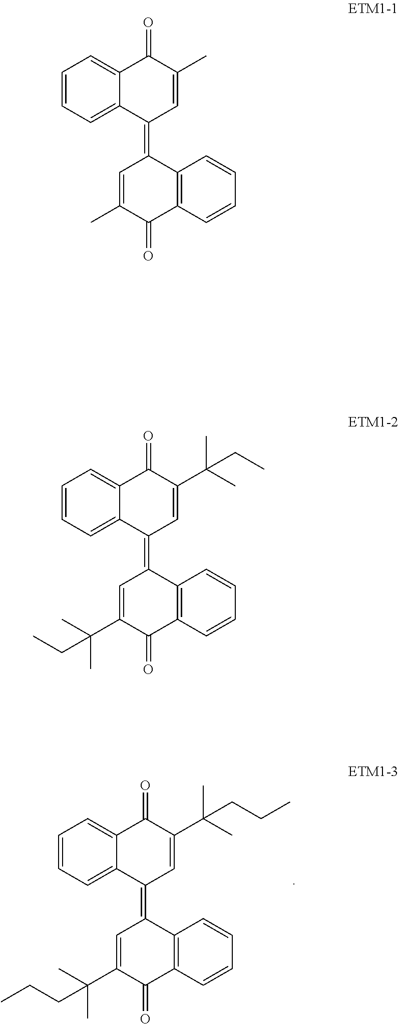

Preferable examples of General Formula (2) are compounds represented by chemical formulae (ETM2-1, ETM2-2 and ETM2-3).

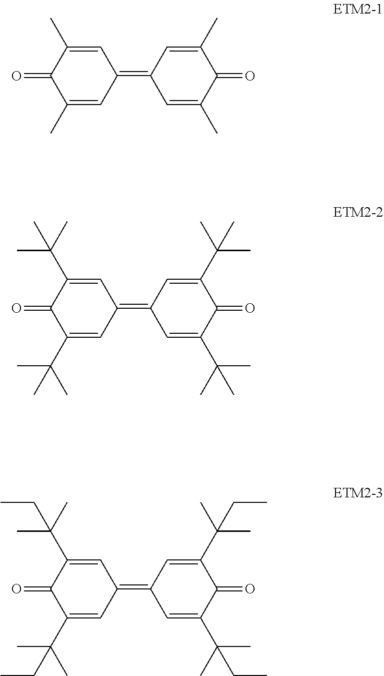

Preferable examples of General Formula (3) are compounds represented by chemical formulae (ETM3-1, ETM3-2 and ETM3-3).

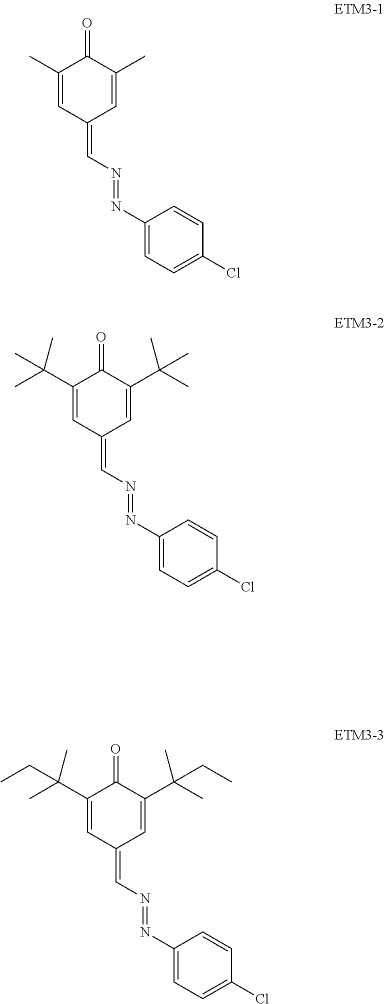

Preferable examples of General Formula (4) are compounds represented by chemical formulae (ETM4-1, ETM4-2 and ETM4-3).

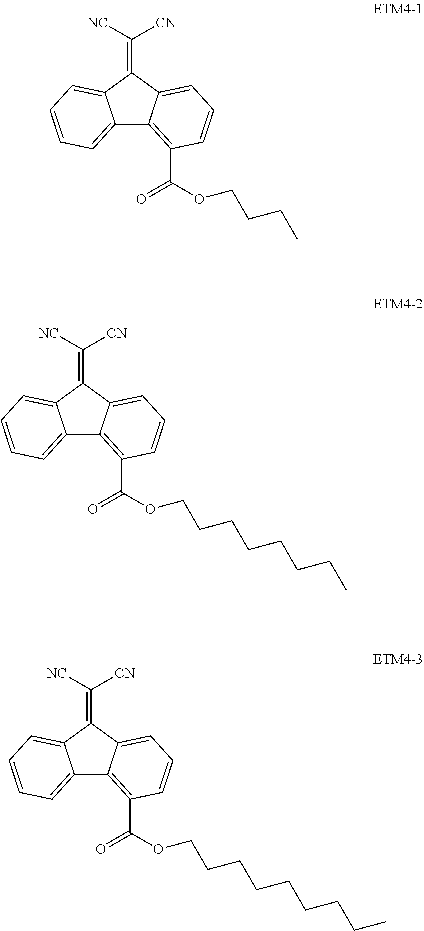

A preferable example of General Formula (5) includes ETM5-1.

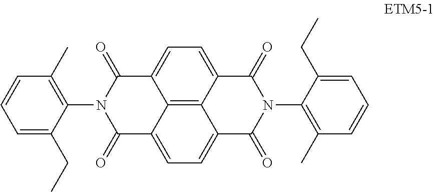

The hole transport material includes oxadiazole derivatives such as 2,5-bis(p-diethylaminophenyl)-1,3,4-oxadiazole; pyrazoline derivatives such as 1,3,5-triphenyl-pyrazoline and 1-[pyridyl-(2)]-3-(p-diethylaminostyryl)-5-(p-diethylaminostyryl)pyrazoline; aromatic tertiary amino compounds such as triphenylamine, N,N′-bis(3,4-dimethylphenyl)biphenyl-4-amine, tri(p-methylphenyl)aminyl-4-amine and dibenzylaniline; aromatic tertiary diamino compounds such as N,N′-bis(3-methylphenyl)-N,N′-diphenylbenzidine, 1,2,4-triazine derivatives such as 3-(4′-dimethylaminophenyl)-5,6-di-(4′-methoxyphenyl)-1,2,4-triazine; hydrazone derivatives such as 4-diethylamino-benzaldehyde-1,1-diphenyl hydrazone; quinazoline derivatives such as 2-phenyl-4-styryl-quinazoline; benzofuran derivatives such as 6-hydroxy-2,3-di(p-methoxyphenyl)benzofuran; α-stilbene derivatives such as p-(2,2-diphenylvinyl)-N,N-diphenylaniline; enamine derivatives; carbazole derivatives such as N-ethylcarbazole; poly-N-vinylcarbazole and derivatives thereof; and polymers having a group including the above compounds in its main chain or side chain. These hole transport materials may be used singly or in combination of two or more of the above materials.

Specific examples thereof include the hole transport materials represented by General Formula (6) and General Formula (7). Among others, the hole transport material represented by General Formula (6) is preferable.

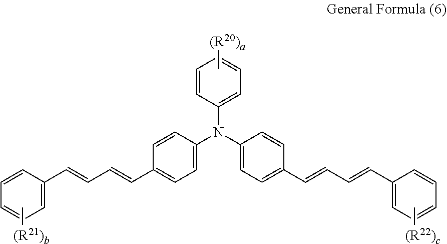

In General Formula (6), R²⁰ to R²² each independently represent an alkyl group having 1 or more and 6 or less carbon atoms, an alkoxy group having 1 or more and 6 or less carbon atoms, or an aryl group having 6 or more and 14 or less carbon atoms. It is preferable for R²⁰ to R²² to represent an alkyl group having 1 or more and 6 or less carbon atoms, and is more preferable to represent an n-butyl group.

In General Formula (6), a, b and c each independently represent an integer of 0 or larger and 5 or smaller. When a represents an integer of 2 or larger and 5 or smaller, a plurality of R²⁰s bonding to the same phenyl group may be the same as or different from each other. When a represents an integer of 2 or larger and 5 or smaller, a plurality of R²¹s bonding to the same phenyl group may be the same as or different from each other. When c represents an integer of 2 or larger and 5 or smaller, a plurality of R²²s bonding to the same phenyl group may be the same as or different from each other. It is preferable that a represents 1. It is preferable that b and c represent 0.

Bonding positions of R²⁰ and R²¹ are not limited in particular. R²⁰ to R²² each may bond to (be positioned at) any of the ortho, meta and para positions of the phenyl group. It is preferable that R²⁰ bonds to the para position of the phenyl group.

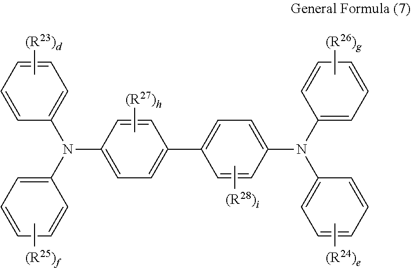

In General Formula (7), R²³ to R²⁸ each independently represent an alkyl group having 1 or more and 6 or less carbon atoms, an alkoxy group having 1 or more and 6 or less carbon atoms, or an aryl group having 6 or more and 14 or less carbon atoms. It is preferable for R²³ to R²⁸ to each represent an alkyl group having 1 or more and 6 or less carbon atoms, is more preferable to each represent an alkyl group having 1 or more and 3 or less carbon atoms, and is particularly preferable to each represent a methyl group.

In General Formula (7), d, e, f and g each independently represent an integer of 0 or larger and 5 or smaller. When d represents an integer of 2 or larger and 5 or smaller, a plurality of R²³s bonding to the same phenyl group may be the same as or different from each other. When e represents an integer of 2 or larger and 5 or smaller, a plurality of R²⁴s bonding to the same phenyl group may be the same as or different from each other. When f represents an integer of 2 or larger and 5 or smaller, a plurality of R²⁵s bonding to the same phenyl group may be the same as or different from each other. When g represents an integer of 2 or larger and 5 or smaller, a plurality of R²⁶s bonding to the same phenyl group may be the same as or different from each other. It is preferable that d and g each represent 1. It is more preferable that e and f each represent 0.

The bonding positions of R²³ to R²⁶ are not limited in particular. R²³ to R²⁶ each may bond to (be positioned at) any of the ortho, meta and para positions of the phenyl group. It is preferable that R²³ and R²⁶ each bond to the para position of the phenyl group.

In General Formula (7), h and i each independently represent an integer of 0 or larger and 4 or smaller. When h represents an integer of 2 or larger and 4 or smaller, a plurality of R's bonding to the same phenylene group may be the same as or different from each other. When i represents an integer of 2 or larger and 4 or smaller, a plurality of R²⁸s bonding to the same phenylene group may be the same as or different from each other. It is preferable that h and i each represent 0.

The bonding positions of R^{2′} and R²⁸ are not limited in particular. R^{2′} and R²⁸ each may bond to (be positioned at) any of an ortho position or a meta position with respect to a nitrogen atom to which the phenylene group bonds.

A preferable example of General Formula (6) is a compound represented by following chemical formula (HTM1-1).

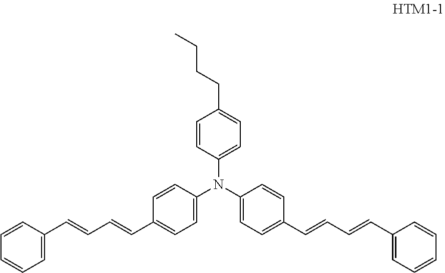

A preferable example of General Formula (7) is a compound represented by following chemical formula (HTM2-1).

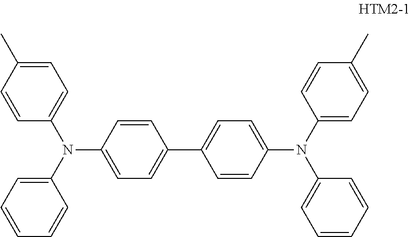

In the photosensitive layer having a mono-layer structure, it is more preferable that the content of the electron transport material is 200% by mass or more and 1000% by mass or less with respect to the charge generation material, from the viewpoint of suppression of the exposure memory.

It is more preferable that the content of the electron transport material in the photosensitive layer having a mono-layer structure is 10% by mass or more and 30% by mass or less with respect to the binder resin in the photosensitive layer having a mono-layer structure, and that the content of strontium titanate in the undercoat layer is 100% by mass or more and 500% by mass or less with respect to a binder resin, from the viewpoint of suppression of the exposure memory.

The film thickness of the photosensitive layer having a mono-layer structure is preferably 10 μm or larger and 40 μm or smaller, from the viewpoint of suppression of the exposure memory.

It is preferable that the content of the hole transport material in the photosensitive layer having a mono-layer structure is 25% by mass or more and 130% by mass or less with respect to the binder resin in the photosensitive layer having a mono-layer structure, from the viewpoint of suppression of the exposure memory.

The photosensitive layer having a mono-layer structure may contain other known additives such as a surface-active agent, an antioxidizing agent, a light stabilizer and a heat stabilizer. In addition, when the photosensitive layer having a mono-layer structure is a surface layer, the photosensitive layer may contain fluorine resin particles, silicone oil and the like.

<Protective Layer>

In the present disclosure, a protective layer may be provided on the photosensitive layer. By having the protective layer provided therein, the electrophotographic photosensitive member can improve its durability.

It is preferable that the protective layer contains an electroconductive particles and/or a charge transport material, and a resin.

The electroconductive particles include particles of metal oxides such as titanium oxide, zinc oxide, tin oxide and indium oxide.

The charge transport materials include a polycyclic aromatic compound, a heterocyclic compound, a hydrazone compound, a styryl compound, an enamine compound, a benzidine compound, a triarylamine compound, and resins having a group derived from these materials. Among others, the triarylamine compound and the benzidine compound are preferable.

The resins include a polyester resin, an acrylic resin, a phenoxy resin, a polycarbonate resin, a polystyrene resin, a phenol resin, a melamine resin and an epoxy resin. Among others, the polycarbonate resin, the polyester resin and the acrylic resin are preferable.

In addition, the protective layer may be formed as a cured film by the polymerization of a composition which contains a monomer having a polymerizable functional group. Reactions at this time include a thermal polymerization reaction, a photopolymerization reaction, and a radiation-induced polymerization reaction. The polymerizable functional groups that the monomer which has a polymerizable functional group has include an acryl group and methacryl group. As a monomer having the polymerizable functional group, a material having a charge transport capability may be used.

The protective layer may contain additives such as an antioxidizing agent, an ultraviolet absorbing agent, a plasticizing agent, a leveling agent, a slipperiness imparting agent and an abrasion resistance improver. The specific additives include a hindered phenol compound, a hindered amine compound, a sulfur compound, a phosphorus compound, a benzophenone compound, a siloxane modified resin, silicone oil, a fluorocarbon resin particle, a polystyrene resin particle, a polyethylene resin particle, a silica particle, an alumina particle and a boron nitride particle.

It is preferable for the average film thickness of the protective layer to be 0.5 μm or larger and 10 μm or smaller, and is more preferable to be 1 μm or larger and 7 μm or smaller.

The protective layer can be formed by preparing a coating liquid for the protective layer, which contains each of the above materials and a solvent, forming the coating film of the coating liquid, and drying and/or curing the coating film. The solvents used for the coating liquid include an alcohol-based solvent, a ketone-based solvent, an ether-based solvent, a sulfoxide-based solvent, an ester-based solvent and an aromatic hydrocarbon-based solvent.

<Process Cartridge>

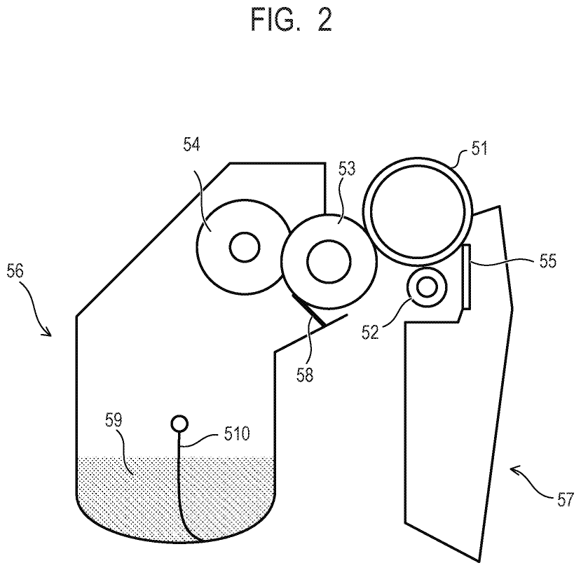

The present disclosure relates to a process cartridge that integrally supports the above electrophotographic photosensitive member and at least one unit selected from the group consisting of a charging unit, a developing unit, a transfer unit and a cleaning unit, and that is detachably attachable to a main body of the electrophotographic apparatus. FIG. 2 illustrates a schematic cross-sectional view of the process cartridge for electrophotography, which has an electrophotographic photosensitive member unit. The process cartridge is structured to integrate a developing apparatus with a charging apparatus, and to be detachably attachable to the main body of the electrophotographic apparatus. The developing apparatus is an apparatus in which at least a developing roller 53 and a toner container 56 are integrated, and may be provided with a toner supply roller 54, a toner 59, a developing blade 58 and a stirring blade 510, as needed. The charging apparatus is an apparatus in which at least a photosensitive drum 51 of the electrophotographic photosensitive member unit, a cleaning blade 55 and a charging roller 52 are integrated, and may have a waste toner container 57. The charging roller 52, the developing roller 53, the toner supply roller 54 and the developing blade 58 are structured so that a voltage is applied to each of the rollers and the blade.

<Electrophotographic Apparatus>

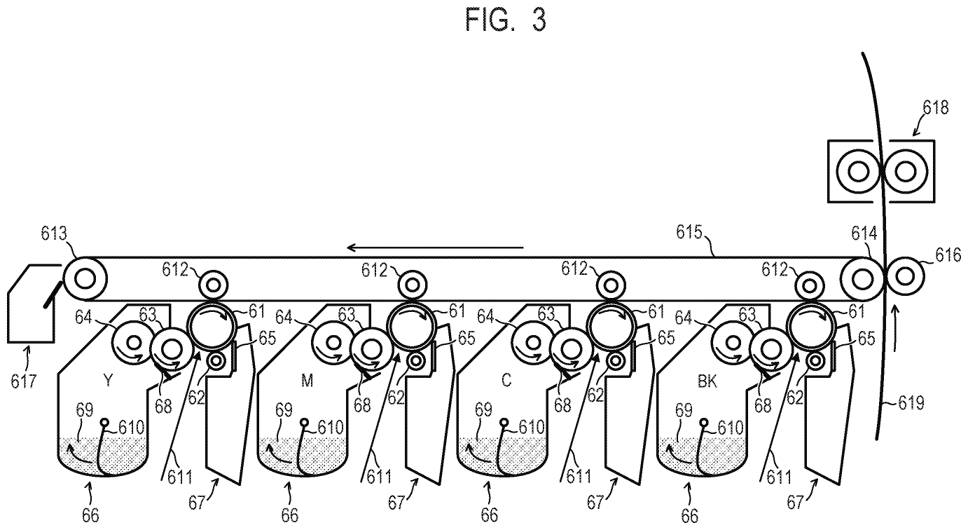

The present disclosure relates to the electrophotographic apparatus having the above electrophotographic photosensitive member, charging unit, exposure unit, developing unit and transfer unit. FIG. 3 is a schematic view of the electrophotographic apparatus having the electrophotographic photosensitive member unit. This electrophotographic apparatus is a color electrophotographic apparatus in which four of the above process cartridges are detachably mounted. In each of the process cartridges, a toner of each color of black, magenta, yellow and cyan is used. A photosensitive drum 61 of the electrophotographic photosensitive member unit rotates in the direction of the arrow, is uniformly charged by a charging roller 62 to which a voltage is applied from a charging bias power source, and an electrostatic latent image is formed on its surface by exposure light 611.

On the other hand, a toner 69 stored in a toner container 66 is supplied to a toner supply roller 64 by a stirring blade 610, and is conveyed from the toner supply roller 64 onto a developing roller 63. Then, the surface of the developing roller 63 is uniformly coated with the toner 69 by a developing blade 68 which is arranged in contact with the developing roller 63, and at the same time, an electric charge is given to the toner 69 by frictional charging.

The above electrostatic latent image is developed by the toner 69 being given that is conveyed by the developing roller 63 which is arranged in contact with the photosensitive drum 61, and is visualized as a toner image.

The visualized toner image on the photosensitive drum is transferred to an intermediate transfer belt 615 which is supported and driven by a tension roller 613 and an intermediate transfer belt drive roller 614, by a primary transfer roller 612 to which a voltage is applied by a primary transfer bias power source. The toner images of each of the colors are sequentially superimposed, and a color image is formed on the intermediate transfer belt.

A transfer material 619 is fed into the apparatus by a feed roller (not illustrated), and is conveyed to between the intermediate transfer belt 615 and a secondary transfer roller 616. The secondary transfer roller 616 receives a voltage from a secondary transfer bias power source (not illustrated), and transfers the color image on the intermediate transfer belt 615 to the transfer material 619. The transfer material 619 to which the color image has been transferred is subjected to fixing treatment by a fixing unit 618, and is discharged out of the apparatus; and the printing operation ends.

On the other hand, the toner which has remained on the photosensitive drum without being transferred is scraped off by a cleaning blade 65 and is stored in a waste toner storage container 67, and the cleaned photosensitive drum 61 is repeatedly used in the above process. In addition, the toner which has remained on the intermediate transfer belt 615 without being transferred is also scraped off by a cleaning apparatus 617.

### Example

The present disclosure will be described below in more detail with reference to Examples and Comparative Examples. The present disclosure is not intended to be limited to the following Examples at all as long as the present disclosure does not depart from the gist thereof. Herein, “part(s)” in the following Examples is on a mass basis unless otherwise particularly noted.

[Method for Producing Strontium Titanate Particles]

A water-containing titanium oxide slurry obtained by hydrolysis of an aqueous solution of titanyl sulfate was washed with an aqueous alkaline solution.

Next, hydrochloric acid was added to the slurry of water-containing titanium oxide, the pH was adjusted to 0.7, and a titania sol dispersion liquid was obtained. An aqueous solution of strontium chloride was added in an amount of 1.1-fold by mol relative to 2.2 mol of the titania sol dispersion liquid (in terms of titanium oxide), and the mixture liquid was charged in a reaction vessel and purged with nitrogen gas. Furthermore, pure water was added so that the concentration of the above liquid became 1.1 mol/L in terms of titanium oxide.

Next, the above mixture liquid was stirred and mixed, and was heated to 90° C.; and then 440 mL of a 10 N aqueous solution of sodium hydroxide was added thereto over 15 minutes while ultrasonic vibration was applied thereto, and then was subjected to a reaction for 20 minutes.

Pure water of 5° C. was added to the slurry after the reaction, the mixture was rapidly cooled to 30° C. or lower, and the supernatant was removed.

Furthermore, an aqueous solution of hydrochloric acid with a pH of 5.0 was added to the above slurry, the mixture was stirred for 1 hour, and washing by pure water was repeated. Furthermore, the resultant liquid was neutralized with sodium hydroxide, the neutralized liquid was filtered by a Nutsche funnel, and the residue was washed with pure water. An obtained cake was dried to obtain particles S-1.

### Example 1

An aluminum cylinder was prepared as a support, of which the length was 357.5 mm, the thickness was 0.7 mm, and the outer diameter was 30 mm.

Next, 15 parts of a butyral resin (trade name: BM-1, produced by Sekisui Chemical Co., Ltd.) of a polyol resin, and 15 parts of blocked isocyanate (trade name: Sumidur 3175, produced by Sumika Bayer Urethane Co., Ltd.) were dissolved in a mixed liquid of 300 parts of methyl ethyl ketone and 300 parts of 1-butanol.

Into this solution, 90 parts of the particles S-1 of as the strontium titanate particles, and 1.2 parts of 2,3,4-trihydroxybenzophenone (produced by Tokyo Chemical Industry Co., Ltd.) as an additive, and 1 part of silicone resin particles (trade name: Tospearl 120, produced by Momentive Performance Materials Japan, Ltd. (Old: Toshiba Silicone Co., Ltd.)) were added, and the particles were dispersed by a sand mill apparatus using glass beads having a diameter of 0.8 mm, under an atmosphere of 23±3° C. for 3 hours.

After the dispersion, 0.01 part of silicone oil (trade name: SH28PA, produced by Dow Corning Toray Co., Ltd.) was added to the dispersion liquid, the mixture was stirred, and a coating liquid for the undercoat layer was obtained.

The above support was dip-coated with the obtained coating liquid for the undercoat layer, the coated support was dried for 30 minutes at 160° C., and an undercoat layer was formed which had a film thickness of 5.0 μm.

After the undercoat layer had been formed, the surface roughness on the undercoat layer was measured with a surface roughness measuring instrument (model: SE700) manufactured by Kosaka Laboratory Ltd. The surface roughness was measured under conditions that a cutoff value was 0.8 mm, a measurement length was 4 mm, and a data interval was 1.6 μm. The ten-point average roughness Rzⱼᵢₛ which was determined according to JIS B 0601: 2001 was determined from the measured roughness curve on the undercoat layer.

[Formation of Photosensitive Layer Having a Mono-Layer Structure]

A mixture was prepared that was formed from 2 parts by mass of hydroxygallium phthalocyanine which works as a charge generation material and has a diffraction peak at a position at least of 7.3°, 16.0°, 24.9° and 28.0° based on the Bragg angle)(2θ±0.2° of an X-ray diffraction spectrum using a characteristic X-ray of CuKα, 50 parts by mass of a copolymerizable type polycarbonate resin (viscosity average molecular weight of 50000) which works as a binder resin and is represented by following Formula (P), 250 parts by mass of tetrahydrofuran, and 20 parts by mass of toluene; and was dispersed by a sand mill using glass beads with a diameter of 1 mm ϕ, for 3 hours. The glass beads were filtered; into the obtained dispersion liquid, 30 parts by mass of the already described hole transport material (HTM1-1), 10 parts by mass of the already described electron transport material (ETM1-1) and 0.001 parts by mass of silicone oil KP340 (produced by Shin-Etsu Chemical Co., Ltd.) were added; the mixture was stirred overnight (12 hours); and a coating liquid for forming a photosensitive layer was obtained. The undercoat layer was dip-coated with the coating liquid for forming the photosensitive layer, and the coating liquid was dried at 125° C. for 1 hour, and a photosensitive layer having a mono-layer structure was formed which had a film thickness of 30 μm; and thereby an electrophotographic photosensitive member was produced. Note that a number in Formula (P) shows a content (molar ratio) of each structural unit.

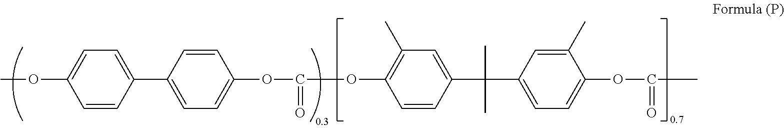

### Example 2

An electrophotographic photosensitive member was produced under the same conditions as those in Example 1, except that the amount of the added silicone resin particles which were used for the undercoat layer was changed to 0.5 parts.

### Example 3

An electrophotographic photosensitive member was produced under the same conditions as those in Example 1, except that the amount of the added silicone resin particles which were used for the undercoat layer was changed to 1.5 parts.

### Example 4

An electrophotographic photosensitive member was produced under the same conditions as those in Example 1, except that the amount of the added silicone resin particles which were used for the undercoat layer was changed to 0.3 parts.

### Example 5

An electrophotographic photosensitive member was produced under the same conditions as those in Example 1, except that the amount of the added silicone resin particles which were used for the undercoat layer was changed to 2 parts.

### Example 6

An electrophotographic photosensitive member was produced under the same conditions as those in Example 5, except that the film thickness of the photosensitive layer having a mono-layer structure was changed to 10 μm by adjustment of a pull-up speed at the time of the dip coating.

### Example 7

An electrophotographic photosensitive member was produced under the same conditions as those in Example 5, except that the film thickness of the photosensitive layer having a mono-layer structure was changed to 40 μm by the adjustment of the pull-up speed at the time of the dip coating.

### Example 8

An electrophotographic photosensitive member was produced under the same conditions as those in Example 5, except that the film thickness of the photosensitive layer having a mono-layer structure was changed to 8 μm by the adjustment of the pull-up speed at the time of the dip coating.

### Example 9

An electrophotographic photosensitive member was produced under the same conditions as those in Example 5, except that the film thickness of the photosensitive layer having a mono-layer structure was changed to 45 μm by the adjustment of the pull-up speed at the time of the dip coating.

### Example 10

An electrophotographic photosensitive member was produced under the same conditions as those in Example 9, except that the amount of the added charge generation material which was used for the photosensitive layer having a mono-layer structure was changed to 5 parts.

### Example 11

An electrophotographic photosensitive member was produced under the same conditions as those in Example 9, except that the amount of the added charge generation material which was used for the photosensitive layer having a mono-layer structure was changed to 1 part.

### Example 12

An electrophotographic photosensitive member was produced under the same conditions as those in Example 9, except that the amount of the added charge generation material which was used for the photosensitive layer having a mono-layer structure was changed to 5.5 parts.

### Example 13

An electrophotographic photosensitive member was produced under the same conditions as those in Example 9, except that the amount of the added charge generation material which was used for the photosensitive layer having a mono-layer structure was changed to 0.9 parts.

### Example 14

An electrophotographic photosensitive member was produced under the same conditions as those in Example 13, except that the hole transport material represented by HTM2-1 was used for the photosensitive layer having a mono-layer structure.

### Example 15

An electrophotographic photosensitive member was produced under the same conditions as those in Example 14, except that the electron transport material represented by ETM-1-2 was used for the photosensitive layer having a mono-layer structure.

### Example 16

An electrophotographic photosensitive member was produced under the same conditions as those in Example 14, except that the electron transport material represented by ETM-1-3 was used for the photosensitive layer having a mono-layer structure.

### Example 17

An electrophotographic photosensitive member was produced under the same conditions as those in Example 14, except that the electron transport material represented by ETM-2-1 was used for the photosensitive layer having a mono-layer structure.

### Example 18

An electrophotographic photosensitive member was produced under the same conditions as those in Example 14, except that the electron transport material represented by ETM-2-2 was used for the photosensitive layer having a mono-layer structure.

### Example 19

An electrophotographic photosensitive member was produced under the same conditions as those in Example 14, except that the electron transport material represented by ETM-2-3 was used for the photosensitive layer having a mono-layer structure.

### Example 20

An electrophotographic photosensitive member was produced under the same conditions as those in Example 14, except that the electron transport material represented by ETM-3-1 was used for the photosensitive layer having a mono-layer structure.

### Example 21

An electrophotographic photosensitive member was produced under the same conditions as those in Example 14, except that the electron transport material represented by ETM-3-2 was used for the photosensitive layer having a mono-layer structure.

### Example 22

An electrophotographic photosensitive member was produced under the same conditions as those in Example 14, except that the electron transport material represented by ETM-3-3 was used for the photosensitive layer having a mono-layer structure.

### Example 23

An electrophotographic photosensitive member was produced under the same conditions as those in Example 14, except that the electron transport material represented by ETM-4-1 was used for the photosensitive layer having a mono-layer structure.

### Example 24

An electrophotographic photosensitive member was produced under the same conditions as those in Example 14, except that the electron transport material represented by ETM-4-2 was used for the photosensitive layer having a mono-layer structure.

### Example 25

An electrophotographic photosensitive member was produced under the same conditions as those in Example 14, except that the electron transport material represented by ETM-4-3 was used for the photosensitive layer having a mono-layer structure.

### Example 26

An electrophotographic photosensitive member was produced under the same conditions as those in Example 16, except that the amount of the added strontium titanate particles S-1 which were used for the undercoat layer was changed to 30 parts.

### Example 27

An electrophotographic photosensitive member was produced under the same conditions as those in Example 16, except that the amount of the added strontium titanate particles S-1 which were used for the undercoat layer was changed to 150 parts.

### Example 28

An electrophotographic photosensitive member was produced under the same conditions as those in Example 16, except that the amount of the added strontium titanate particles S-1 which were used for the undercoat layer was changed to 24 parts.

### Example 29

An electrophotographic photosensitive member was produced under the same conditions as those in Example 16, except that the amount of the added strontium titanate particles S-1 which were used for the undercoat layer was changed to 156 parts.

### Example 30

An electrophotographic photosensitive member was produced under the same conditions as those in Example 29, except that the amount of the added binder resin which was used for the photosensitive layer having a mono-layer structure was changed to 100 parts.

### Example 31

An electrophotographic photosensitive member was produced under the same conditions as those in Example 29, except that the amount of the added binder resin which was used for the photosensitive layer having a mono-layer structure was changed to 34 parts.

### Example 32

An electrophotographic photosensitive member was produced under the same conditions as those in Example 29, except that the amount of the added binder resin which was used for the photosensitive layer having a mono-layer structure was changed to 29 parts.

### Example 33

An electrophotographic photosensitive member was produced under the same conditions as those in Example 29, except that the amount of the added binder resin which was used for the photosensitive layer having a mono-layer structure was changed to 120 parts.

### Example 34

An electrophotographic photosensitive member was produced under the same conditions as those in Example 33, except that the electron transport material represented by ETM-2-3 was used for the photosensitive layer having a mono-layer structure.

### Example 35

An electrophotographic photosensitive member was produced under the same conditions as those in Example 33, except that the electron transport material represented by ETM-3-3 was used for the photosensitive layer having a mono-layer structure.

### Example 36

An electrophotographic photosensitive member was produced under the same conditions as those in Example 33, except that the electron transport material represented by ETM-4-3 was used for the photosensitive layer having a mono-layer structure.

### Example 37

An electrophotographic photosensitive member was produced under the same conditions as those in Example 33, except that the electron transport material represented by ETM-5-1 was used for the photosensitive layer having a mono-layer structure.

### Comparative Example 1

An electrophotographic photosensitive member was produced under the same conditions as those in Example 33, except that a zinc oxide particles (average particle size of 70 nm) were used instead of the strontium titanate particles which were used for the undercoat layer.

### Comparative Example 2

An electrophotographic photosensitive member was produced under the same conditions as those in Example 33, except that titanium oxide particles (average particle size of 35 nm) were used instead of the strontium titanate particles which were used for the undercoat layer.

### Comparative Example 3

An electrophotographic photosensitive member was produced under the same conditions as those in Example 33, except that a photosensitive layer having a mono-layer structure was formed without having the undercoat layer provided on the support.

[Evaluation]

The electrophotographic photosensitive members produced in Examples 1 to 37 and Comparative Examples 1 to 3 were subjected to evaluation.

[Evaluation of Exposure Memory]

The produced photosensitive member was mounted on a modified machine of a copying machine Image Press C800 (2400 dpi) manufactured by Canon Inc., and the exposure memory was evaluated.

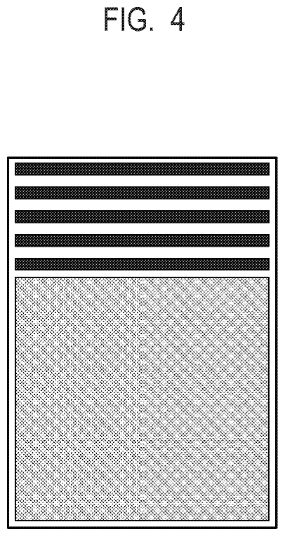

A test chart of A3 illustrated in FIG. 4 was used. In this test chart, there is a pattern in which solid white and solid black repeat, on the front-end side of the image, and after the pattern, a halftone with an area ratio of 25% is formed. An image density of the halftone area that corresponds to the second cycle of the photosensitive member portion on which the image of the solid white and the solid black was formed in the first cycle of the photosensitive member was measured with a reflection densitometer (manufactured by X-Rite Incorporated: 504 Spectral densitometer). Specifically, a difference was determined between an average density of 5 points corresponding to the solid black portion and an average density of 5 points corresponding to the solid white portion.

In this evaluation, a relative value at the time when a density difference in Comparative Example 1 was regarded as 1 was used as an evaluation value. The evaluation value shows that the smaller the numerical value is, the more adequate the exposure memory is.

The results are shown in Table 1.

[Evaluation of Black Point]

The produced photosensitive member was mounted on a modified machine of a copying machine Image Press C800 (2400 dpi) manufactured by Canon Inc., and the black point was evaluated. Ten sheets of the halftone image having an area ratio of 25% were output, and the tenth image was visually evaluated. The number of black points was regarded as an evaluation value. The evaluation value shows that the smaller the numerical value is, the better the evaluation value is.

The results are shown in Table 1.

[Comprehensive Evaluation]

It was determined that when the evaluation value of the evaluation of the exposure memory was smaller than 0.8 and the number of the black points was 9 or smaller, the effects of the present disclosure were exhibited.

TABLE 1

| | | | Photosensitive layer having a mono-layer structure | | | | | | |
|---|---|---|---|---|---|---|---|---|---|
| | | | | | | | Mass of | | |
| | Undercoat layer | | | | | Mass of | electron | | |
| | Mass of | | | | | electron | transport | | |
| | strontium | | | | | transport | material | | |
| | titanate | | | | Film thickness | material | with | | |
| | particles | Rzⱼᵢₛ (μm) | | | of photosensitive | with | respect to | | |
| | with respect | of surface | Electron | Hole | layer having a | respect to | charge | Evaluation | |
| | to binder | of undercoat | transport | transport | mono-layer | binder | generation | Exposure | Black |
| | resin (%) | layer | material | material | structure (μm) | resin (%) | material (%) | memory | spot |
| Example 1 | 300 | 1 | ETM1-1 | HTM1-1 | 30 | 20 | 500 | 0.15 | 1 |
| Example 2 | 300 | 0.5 | ETM1-1 | HTM1-1 | 30 | 20 | 500 | 0.16 | 1 |
| Example 3 | 300 | 1.5 | ETM1-1 | HTM1-1 | 30 | 20 | 500 | 0.17 | 1 |
| Example 4 | 300 | 0.4 | ETM1-1 | HTM1-1 | 30 | 20 | 500 | 0.16 | 3 |
| Example 5 | 300 | 1.6 | ETM1-1 | HTM1-1 | 30 | 20 | 500 | 0.16 | 3 |
| Example 6 | 300 | 1.6 | ETM1-1 | HTM1-1 | 10 | 20 | 500 | 0.15 | 4 |
| Example 7 | 300 | 1.6 | ETM1-1 | HTM1-1 | 40 | 20 | 500 | 0.16 | 3 |
| Example 8 | 300 | 1.6 | ETM1-1 | HTM1-1 | 8 | 20 | 500 | 0.21 | 5 |
| Example 9 | 300 | 1.6 | ETM1-1 | HTM1-1 | 45 | 20 | 500 | 0.22 | 6 |
| Example 10 | 300 | 1.6 | ETM1-1 | HTM1-1 | 45 | 20 | 200 | 0.23 | 6 |
| Example 11 | 300 | 1.6 | ETM1-1 | HTM1-1 | 45 | 20 | 1000 | 0.22 | 5 |
| Example 12 | 300 | 1.6 | ETM1-1 | HTM1-1 | 45 | 20 | 1050 | 0.29 | 5 |
| Example 13 | 300 | 1.6 | ETM1-1 | HTM1-1 | 45 | 20 | 80 | 0.30 | 6 |
| Example 14 | 300 | 1.6 | ETM1-1 | HTM2-1 | 45 | 20 | 1050 | 0.40 | 5 |
| Example 15 | 300 | 1.6 | ETM1-2 | HTM2-1 | 45 | 20 | 1050 | 0.40 | 6 |
| Example 16 | 300 | 1.6 | ETM1-3 | HTM2-1 | 45 | 20 | 1050 | 0.51 | 6 |
| Example 17 | 300 | 1.6 | ETM2-1 | HTM2-1 | 45 | 20 | 1050 | 0.41 | 6 |
| Example 18 | 300 | 1.6 | ETM2-2 | HTM2-1 | 45 | 20 | 1050 | 0.42 | 5 |
| Example 19 | 300 | 1.6 | ETM2-3 | HTM2-1 | 45 | 20 | 1050 | 0.51 | 5 |
| Example 20 | 300 | 1.6 | ETM3-1 | HTM2-1 | 45 | 20 | 1050 | 0.42 | 5 |
| Example 21 | 300 | 1.6 | ETM3-2 | HTM2-1 | 45 | 20 | 1050 | 0.41 | 5 |
| Example 22 | 300 | 1.6 | ETM3-3 | HTM2-1 | 45 | 20 | 1050 | 0.52 | 5 |
| Example 23 | 300 | 1.6 | ETM4-1 | HTM2-1 | 45 | 20 | 1050 | 0.42 | 5 |
| Example 24 | 300 | 1.6 | ETM4-2 | HTM2-1 | 45 | 20 | 1050 | 0.43 | 5 |
| Example 25 | 300 | 1.6 | ETM4-3 | HTM2-1 | 45 | 20 | 1050 | 0.51 | 6 |
| Example 26 | 100 | 1.6 | ETM1-3 | HTM2-1 | 45 | 20 | 1050 | 0.52 | 4 |
| Example 27 | 500 | 1.6 | ETM1-3 | HTM2-1 | 45 | 20 | 1050 | 0.51 | 6 |
| Example 28 | 80 | 1.6 | ETM1-3 | HTM2-1 | 45 | 20 | 1050 | 0.60 | 4 |
| Example 29 | 520 | 1.6 | ETM1-3 | HTM2-1 | 45 | 20 | 1050 | 0.60 | 5 |
| Example 30 | 520 | 1.6 | ETM1-3 | HTM2-1 | 45 | 10 | 1050 | 0.61 | 6 |
| Example 31 | 520 | 1.6 | ETM1-3 | HTM2-1 | 45 | 30 | 1050 | 0.61 | 7 |
| Example 32 | 520 | 1.6 | ETM1-3 | HTM2-1 | 45 | 35 | 1050 | 0.67 | 6 |
| Example 33 | 520 | 1.6 | ETM1-3 | HTM2-1 | 45 | 8 | 1050 | 0.68 | 6 |
| Example 34 | 520 | 1.6 | ETM2-3 | HTM2-1 | 45 | 8 | 1050 | 0.69 | 5 |
| Example 35 | 520 | 1.6 | ETM3-3 | HTM2-1 | 45 | 8 | 1050 | 0.68 | 6 |
| Example 36 | 520 | 1.6 | ETM4-3 | HTM2-1 | 45 | 8 | 1050 | 0.67 | 6 |
| Example 37 | 520 | 1.6 | ETM5-1 | HTM2-1 | 45 | 8 | 1050 | 0.77 | 6 |
| Comparative | (Zinc oxide | 1.6 | ETM1-3 | HTM2-1 | 45 | 8 | 1050 | 1.00 | 8 |
| Example 1 | particle) | | | | | | | | |
| | 520 | | | | | | | | |
| Comparative | (Titanium oxide | 1.6 | ETM1-3 | HTM2-1 | 45 | 8 | 1050 | 1.03 | 9 |
| Example 2 | particle) | | | | | | | | |
| | 520 | | | | | | | | |
| Comparative | — | — | ETM1-3 | HTM2-1 | 45 | 8 | 1050 | 0.85 | 16 |
| Example 3 | | | | | | | | | |

It is understood from the evaluation results that in Examples 1 to 37, the exposure memory and the black point are improved as compared with those in Comparative Examples, and the effects of the present disclosure are obtained.

As described above with reference to the embodiments and Examples, according to the present disclosure, the suppression of both the black spot and the exposure memory can be achieved.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-200118, filed Oct. 24, 2018, which is hereby incorporated by reference herein in its entirety.

What is claimed is:

1. An electrophotographic photosensitive member comprising a support, an undercoat layer and a photosensitive layer having a mono-layer structure in this order, wherein the undercoat layer contains a binder resin and strontium titanate particles, and the photosensitive layer having a mono-layer structure contains a binder resin, a charge generation material, a hole transport material and an electron transport material.

2. The electrophotographic photosensitive member according to claim 1, wherein the electron transport material is represented by General Formula (1), General Formula (2), General Formula (3) or General Formula (4): 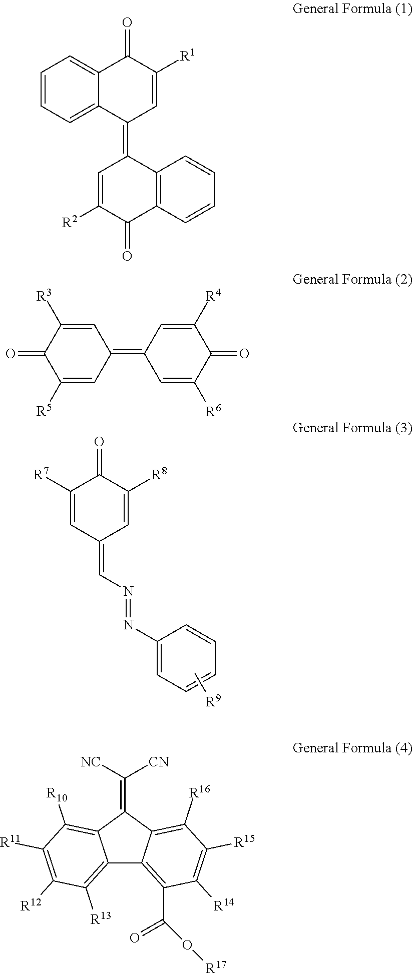
wherein in General Formula (1), R¹ and R² each independently represent a hydrogen atom, a halogen atom, a cyano group, a substituted or unsubstituted alkyl group having 1 or more and 6 or less carbon atoms, a substituted or unsubstituted alkenyl group having 2 or more and 6 or less carbon atoms, a substituted or unsubstituted alkoxy group having 1 or more and 6 or less carbon atoms, or a substituted or unsubstituted aryl group having 6 or more and 14 or less carbon atoms; in General Formula (2), R³, R⁴, R⁵ and R⁶ each independently represent a hydrogen atom, a halogen atom, a cyano group, a substituted or unsubstituted alkyl group having 1 or more and 6 or less carbon atoms, a substituted or unsubstituted alkenyl group having 2 or more and 6 or less carbon atoms, a substituted or unsubstituted alkoxy group having 1 or more and 6 or less carbon atoms, or a substituted or unsubstituted aryl group having 6 or more and 14 or less carbon atoms;
in General Formula (3), R⁷, R⁸ and R⁹ each independently represent a hydrogen atom, a halogen atom, a cyano group, a substituted or unsubstituted alkyl group having 1 or more and 6 or less carbon atoms, a substituted or unsubstituted alkenyl group having 2 or more and 6 or less carbon atoms, a substituted or unsubstituted alkoxy group having 1 or more and 6 or less carbon atoms, or a substituted or unsubstituted aryl group having 6 or more and 14 or less carbon atoms; and
in General Formula (4), R¹⁰, R¹¹, R¹², R¹³, R¹⁴, R¹⁵ and R¹⁶ each independently represent a hydrogen atom, a halogen atom, an alkyl group, an alkoxy group, an aryl group or an aralkyl group, and R¹⁷ represents an alkyl group, an aryl group or an aralkyl group.

3. The electrophotographic photosensitive member according to claim 1, wherein a content of the electron transport material in the photosensitive layer having a mono-layer structure is 10% by mass or more and 30% by mass or less with respect to the binder resin, and a content of the strontium titanate particles in the undercoat layer is 100% by mass or more and 500% by mass or less with respect to the binder resin.

4. The electrophotographic photosensitive member according to claim 1, wherein in the electron transport material, in General Formula (1), R¹ and R² each independently represent an alkyl group having 1 or more and 6 or less carbon atoms; in General Formula (2), R³, R⁴, R⁵ and R⁶ each independently represent an alkyl group having 1 or more and 6 or less carbon atoms; R⁷ and R⁸ in General Formula (3), each independently represent an alkyl group having 1 or more and 6 or less carbon atoms, and R⁹ represents a halogen atom; and in General Formula (4), a group represented by R¹⁷ represents an alkyl group or an aralkyl group having 4 or more and 8 or less carbon atoms.

5. The electrophotographic photosensitive member according to claim 1, wherein the hole transport material is represented by General Formula (6): 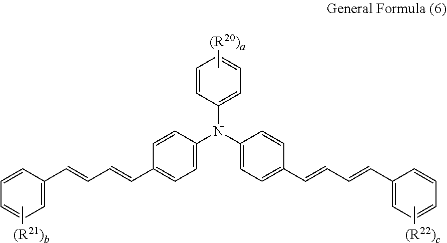
wherein R²⁰ to R²² each independently represent an alkyl group having 1 or more and 6 or less carbon atoms, an alkoxy group having 1 or more and 6 or less carbon atoms, or an aryl group having 6 or more and 14 or less carbon atoms; and a, b and c each independently represent an integer of 0 or larger and 5 or smaller.

6. The electrophotographic photosensitive member according to claim 1, wherein in the photosensitive layer having a mono-layer structure, a content of the electron transport material is 200% by mass or more and 1000% by mass or less with respect to the charge generation material.

7. The electrophotographic photosensitive member according to claim 1, wherein a film thickness of the photosensitive layer having a mono-layer structure is 10 μm or larger and 40 μm or smaller.

8. The electrophotographic photosensitive member according to claim 1, wherein on a surface of the undercoat layer, a ten-point average roughness Rzⱼᵢₛ defined by JIS B 0601: 2001 is 0.5 μm or larger and 1.5 μm or smaller.

9. A process cartridge integrally supporting the electrophotographic photosensitive member comprising a support, an undercoat layer and a photosensitive layer having a mono-layer structure in this order, and at least one unit selected from the group consisting of a charging unit, a developing unit, a transfer unit and a cleaning unit; and being detachably attachable to a main body of an electrophotographic apparatus, wherein the undercoat layer contains a binder resin and strontium titanate particles, and the photosensitive layer having a mono-layer structure contains a binder resin, a charge generation material, a hole transport material and an electron transport material.

10. An electrophotographic apparatus comprising: the electrophotographic photosensitive member comprising a support, an undercoat layer and a photosensitive layer having a mono-layer structure in this order, a charging unit, an exposure unit, a developing unit and a transfer unit, wherein the undercoat layer contains a binder resin and strontium titanate particles, and the photosensitive layer having a mono-layer structure contains a binder resin, a charge generation material, a hole transport material and an electron transport material.
